(19) United States
(12) Patent Application Publication
(10) Pub. No.: US 2014/0279810 A1
(43) Pub. Date: Sep. 18, 2014

(54) SYSTEM AND METHOD FOR DEVELOPING BUSINESS RULES FOR DECISION ENGINES

(71) Applicant: TRANS UNION LLC, Chicago, IL (US)

(72) Inventors: Murray Robert Mann, Alpharetta, GA (US); Melanie Turgeon Zimmerman, Tucker, GA (US); John Michael Fulmer, Avondale Estates, GA (US); Karen O'Bryan Manning, Roswell, GA (US); Timothy Earl Ake, Woodstock, GA (US); Anthony Joseph Okrutny, Mcdonough, GA (US)

(21) Appl. No.: 14/208,739

(22) Filed: Mar. 13, 2014

Related U.S. Application Data
(60) Provisional application No. 61/799,064, filed on Mar. 15, 2013.

(51) Int. Cl. G06N 5/02

(52) U.S. Cl. CPC G06N 5/025
USPC 706/47

(57) ABSTRACT

Systems and methods for developing business rules for decision engines are provided. A user interface may be provided for inputting business rules and one or more sets of data. The business rules may be in a format of a decision table and/or a decision matrix. The business rules may be applied on the sets of data to generate rule feedback, using an internal decision engine, which denotes coverage of the data by the business rules. The rule feedback may be provided on the user interface, such as with a data coverage indicator utilizing colors, and/or data coverage statistics. The business rules may be defined and validated prior to implementation in an external decision engine. Importable business rules that are adapted to be executed by the external decision engine may be generated based on the business rules. Components of the system may be executed locally on a personal computer.

### CROSS REFERENCE TO RELATED APPLICATION

This application claims the benefit of U.S. Provisional Patent Application No. 61/799,064 filed on Mar. 15, 2013, which is incorporated herein by reference in its entirety.

### TECHNICAL FIELD

This invention relates to a system and method for developing business rules for decision engines. More particularly, the invention provides a system and method for allowing a user to define business requirements and their associated business rules by testing and validating the business rules through the use of feedback and statistics, prior to deployment in a decision engine.

### BACKGROUND OF THE INVENTION

Businesses utilize decision engines to make decisions regarding a variety of processes and policies based on attributes and other criteria. Such processes and policies may be related to marketing, fraud, financial management, granting of credit, and other areas. For example, a financial institution may utilize a decision engine to determine whether to grant credit to an individual based on aspects of the individual's credit history. Business rules may define a particular process and the logic of the business rules can be implemented within a decision engine. In some cases, business rules can be precisely and compactly specified and modeled using a decision table or decision matrix, which are generally more easily configurable by and comprehensible to non-technical users.

In a typical business rule development process, a non-technical business person may define business requirements and its associated business rules based on the needs of the business. The business person may interface with a technical developer who can translate the business rules into code for use in a decision engine. The technical developer can test and validate the behavior of the decision engine, based on their understanding of the business rules, but ultimately, the business person generally has the responsibility to ensure the business requirements are met, such as by reviewing the results and output of the decision engine. However, this process may be prone to errors, such as if the translation of the business rules into code for use in the decision engine is not accurate or aspects are omitted or misunderstood. As such, the process may be less than optimal, unnecessarily lengthy, and require multiple iterations between the business person and the technical developer to ensure that the implementation of the business rules into the decision engine is correct.

Therefore, there is a need for an improved system and method that can optimize the management of the business rule development process, in order to, among other things, ease the testing and validation of business rules by non-technical persons and reduce the amount of time needed to develop business rules for decision engines.

### SUMMARY OF THE INVENTION

The invention is intended to solve the above-noted problems by providing systems and methods for developing business rules for an external decision engine by applying the business rules to a set of data to generate and provide rule feedback, and generating importable business rules adapted to be executed by the external decision engine. The systems and methods are designed to, among other things: (1) provide a user interface for enabling a user to input business rules and one or more sets of data; (2) receive the business rules and the one or more sets of data from the user interface; (3) apply the business rules on the one or more sets of data to generate rule feedback; (4) provide the rule feedback on the user interface; and (5) generate importable business rules based on the received business rules that are adapted to be executed by an external decision engine.

In a particular embodiment, a user interface may be provided for enabling a user to input a plurality of business rules and one or more sets of data. The business rules may be in a format of a decision table and/or a decision matrix. The plurality of business rules and the one or more sets of data may be received from the user interface. The plurality of business rules may be applied on the one or more sets of data to generate rule feedback. The plurality of business rules may be executed on the one or more sets of data with an internal decision engine to generate the rule feedback. The rule feedback may be provided on the user interface, such as with a data coverage indicator that indicates whether one or more of the plurality of business rules always fails, always passes, is not reached, or is fully exercised with respect to the one or more sets of data. The data coverage indicator may include one or more colors to uniquely indicate these states. The rule feedback may also include data coverage statistics. A plurality of importable business rules that are adapted to be executed by an external decision engine may be generated based on the plurality of business rules. Some or all of the plurality of importable business rules may be in a machine-readable format adapted to be executed by the external decision engine. The user interface may be enabled to accept a change to at least one of the plurality of business rules and a change to the one or more sets of data after the plurality of business rules and the one or more sets of data are received. The changed business rule(s) can be applied to the changed one or more sets of data to generate further rule feedback.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system for developing business rules for an external decision engine.

FIG. 2 is a block diagram of one form of a computer or server of FIG. 1, having a memory element with a computer readable medium for implementing the system for developing business rules for an external decision engine.

FIG. 3 is a flowchart illustrating operations for developing business rules for an external decision engine using the system of FIG. 1.

FIG. 4 is a flowchart illustrating operations for applying business rules to data to generate rule feedback using the system of FIG. 1.

FIGS. 5-6 are exemplary screenshots of decision tables for use in the system for developing business rules for an external decision engine.

FIGS. 7A-7B are exemplary screenshots of a decision table and a corresponding set of data for use in the system for developing business rules for an external decision engine.

FIG. 8 is an exemplary screenshot of a decision matrix for use in the system for developing business rules for an external decision engine.

FIG. 9 is an exemplary screenshot of a decision matrix and equivalent decision table for use in the system for developing business rules for an external decision engine.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

FIG. 1 illustrates a business rule development system 100 for developing business rules for an external decision engine, in accordance with one or more principles of the invention. The system 100 may utilize business rules and one or more sets of data received from a user interface 102, provide rule feedback to the user interface 102 based on applying the business rules on the set(s) of data with an internal decision engine 106, and generate importable business rules adapted to be executed by an external decision engine 108. Users utilizing the system 100, such as non-technical business persons, are enabled to quickly and easily input, change, and validate business rules prior to being deployed in the external decision engine 108. The business people can therefore ensure that the business rules conform to the requirements of the business, prior to interfacing with a technical developer. In particular, the business requirements can be defined and validated prior to implementation in the external decision engine 108. Accordingly, users can shorten the business rules development process and reduce translation errors by importing a documented and validated set of business rules into the external decision engine 108 from the system 100.

Various components of the system 100 may be implemented using software executable by one or more servers or computers, such as a computing device 200 with a processor 202 and memory 204 as shown in FIG. 2, which is described in more detail below. In some embodiments, the system 100 may be included as an add-in to spreadsheet software, such as Microsoft Excel, and may include worksheets, scripts, executable code, and/or other components. For example, the system 100, including the interface 102, the business rule development module 104, and the internal decision engine 106 may be executed locally on a personal computer.

In an embodiment, a business rule development module 104 in the system 100 may provide a user interface for inputting business rules and one or more sets of data, where the format of the business rules is a decision table or a decision matrix. In other embodiments, the format of the business rules may be in a decision tree or other type of decision structure. The business rule development module 104 may receive the business rules and the set(s) of data from the user interface 102, and utilize an internal decision engine 106 to apply the business rules on the set(s) of data to generate rule feedback. The rule feedback can be provided to the user interface 102 by the business rule development module 104. Importable business rules can be generated by the business rule development module 104 that are adapted to be executed by an external decision engine 108. An external decision engine 108 is a run time execution engine that can understand the importable business rules.

A user interface 102 may be provided by the business rule development module 104. The user interface 102 may be a spreadsheet, such as shown in the exemplary screenshots of FIGS. 5-9, so that a user can input business rules and/or set(s) of data. The business rules can be input in formats such as a decision table, exemplified in the screenshots of FIGS. 5, 6, 7A, and 9, and/or a decision matrix, exemplified in the screenshots of FIGS. 8 and 9. Decision tables and decision matrices are structures which allow business rules to be precisely and compactly captured, while still defining the business rules in an explicit and understandable format.

The module 104 may validate the state of the decision table or decision matrix to ensure that it is logically correct. The status of this validation can be shown in the “Table Status” of the user interface 102, for example. Messages may also be provided on the user interface 102 if there are logical errors, verification errors, errors in format, and/or other problems. The user interface 102 may enable the user to manage the data calculation mode, such as by choosing between “Auto”, “Auto Filtered”, “Manual”, or “Filtered”. The “Auto” data calculation mode may cause the module 104 to automatically recalculate against the entire set(s) of data after any changes have been made to the decision table or decision matrix. The “Auto Filtered” data calculation mode may cause the module 104 to automatically recalculate against a specified subset of the set(s) of data after changes have been made to the decision table or decision matrix. The “Manual” data calculation mode may cause the module 104 to recalculate against the entire set(s) of data when the user manually issues a run command. The “Filtered” data calculation mode may cause the module 104 to recalculate against a specified subset of the set(s) of data when the user manually issues a run command.

The mode may be managed so that automatic calculation, e.g., application of the business rules on the set(s) of data, is not necessarily performed on large sets of data that could last for a significant duration. If automatic calculation is not selected, then the user may manually issue a run command to the module 104, such as by pressing a “Run Now” button. A status of the data calculation may be provided on the user interface 102 to report if the application of business rules on the set(s) of data is successful or has errors. A log file and/or console may be provided through the module 104 for diagnostic purposes. Rule feedback, such as data coverage indicators and data coverage statistics, may be provided by the module 104 on the user interface 102 after business rules are applied on the set(s) of data. Data coverage indicators may include, for example, colors to indicate whether a business rule always fails, always passes, is not reached, or is fully exercised with respect to the set(s) of data. Data coverage statistics may also include counts of how much data passes or fails particular rules.

Decision tables are typically arranged in a grid that includes conditions, rules, actions, and action flags. For example, as shown in FIG. 5, the decision table 500 includes conditions 504 (including attributes, values, operators for comparing the attributes and values, default values, and reason codes), rules 506, actions 508, and action flags 510. The decision table 500 may also include descriptive and configuration information 502, such as a name identifying the decision table, a description of the decision table, the script utilized to interpret the decision table, a selection of the set(s) of data to be applied to the decision table, and timestamp information.

Conditions are combinations of attributes, operators, and values that are evaluated against the set(s) of data. Attributes are the information on which a user wishes to base a particular decision, and can be specified as any meaningful name. In some embodiments, the attribute can be a formula including functions and operands, or can be blank to indicate the duplication of the previous attribute. Operators are utilized to compare the data corresponding to the attributes to the values in the conditions. Operators can include, for example, greater than (“>”), greater than or equal to (“>=”), less than (“<”), less than or equal to (“<=”), equal to (“=”), the presence of the value in a list (“in”), a range inclusive of the endpoints (“:”), a range inclusive of the bottom of the range and up to, but not including the top of the range (“:<”), a range not including the bottom of the range but including the top of the range (“<:”), a range exclusive of the top and the bottom of the range (“<:<”), and a negation of any of the operators (“not”). Other operators could also be used. The value may include any alphabetic, numeric, or alphanumeric value. The value may also include a question mark (“?”) that specifies that the value to be compared is taken from the rules of the decision table and substituted into the conditions. A default value may be specified if the attribute in the set of data has a blank value. A reason code may be specified that is generated if the attribute comparison is false or an adverse action has occurred. The reason code may be utilized by an external decision engine to provide additional information to a user.

For example, as shown in FIG. 7A, the decision table 700 may be used to make a decision on the credit limit for individuals with data in a set of data that corresponds to particular attributes. In the conditions 704 of the decision table 700, data corresponding to the attribute “Age” is compared with the operator “>=” to determine if the data is greater than or equal to the value “21”, data corresponding to the attribute “Debt” is compared with the operator “<=” to determine if the data is less than or equal to the values “1000” or “2000” in the rules 706 (due to the question mark “?” in the value), and data corresponding to the attribute “Score” is compared with the operator “:” to determine if the data is within the range specified by the value “400:600”. The conditions can be applied against the set of data based on the rules 706, as described further below.

Rules are Boolean constructs that indicate the result required of particular conditions for the rule to match. In particular, each column in the decision table may be a rule that represents a combination of attribute comparisons that cause a set of actions to be taken, if the combination of attribute comparisons is met. Accordingly, within a column, any filled cells can be considered to be ANDed together. Each cell in the rules can include “Y”, “N”, be blank, or be a substitution value if the value in the attributes is a question mark “?”. Each column/rule may be checked in sequence from left to right, and the first column/rule that matches may be utilized. Accordingly, the columns corresponding to each rule may be considered to be ORed. In some embodiments, a default rule that would match if none of the other rules match can be specified in the final (e.g., rightmost) column by using the word “ELSE”.

For example, in the decision table 700 as shown in FIG. 7A, the rule in column F specifies that if data corresponding to the Age attribute is not greater than or equal to 21, then that rule would be matched. The next rule in column G specifies that that if data corresponding to the Age attribute is greater than or equal to 21 and data corresponding to the Debt attribute is less than or equal to 1000, then that rule would be matched. The next rule in column H specifies that if data corresponding to the Age attribute is greater than or equal to 21, data corresponding to the Debt attribute is less than or equal to 1000, and data corresponding to the Score attribute is within the range of 400 to 600, then that rule would be matched. The rule in column I specifies that if data corresponding to the Age attribute is greater than or equal to 21, data corresponding to the Debt attribute is less than or equal to 2000, and data corresponding to the Score attribute is not within the range of 400 to 600, then that rule would be matched. The rule in column J specifies that if data corresponding to the Age attribute is greater than or equal to 21, data corresponding to the Debt attribute is less than or equal to 2000, and data corresponding to the Score attribute is within the range of 400 to 600, then that rule would be matched. The default rule in column K specifies that if none of the other rules match, then the default rule is matched.

Action flags are indicated beneath each column/rule to mark which actions to take if a particular rule is matched. Action flags can be specified with “X” or “x”, for example, to mark which actions should be taken if the there is a rule match. The action flags can also be specified as blank if no action is to be taken, or can be specified with a value that is substituted into an action. The actions that can be taken are specified in the rows corresponding to the action flags. Actions can be in formats such as “Set <attribute>=<value>”, where a named attribute or variable can be set to a particular value or set to a value specified in the action flags, or as “Go <target>”, where a final value is returned for directing a next action of the external decision engine. The “<value>” in the Set action may be a static value, a formula, and/or a function, for example. The final value in the “Go <target>” action format can be specified in the action itself, or be set to a value specified in the action flags. Other actions may also be specified.

Returning to the decision table 700 shown in FIG. 7A, the action flags 710 correspond to the rules 706, and the actions 708 correspond to the action flags 710. The rule in column F has an action flag of “UnderAge” for the rule “Go ?”. Therefore, if the rule in column F is matched, then the action that is taken becomes “Go UnderAge” because the “Go ?” action is activated by substituting the value “UnderAge” for “?”. The rule in column G has action flags of “1000” for the rule “Set CreditLimit=?” and “Checking” for the rule “Go ?”. Therefore, if the rule in column G is matched, then the actions that are taken become “Set CreditLimit=1000” and “Go Checking”. The rule in column H has action flags of “1000” for the rule “Set CreditLimit=?” and “CreditCard” for the rule “Go ?”. Therefore, if the rule in column H is matched, then the actions that are taken become “Set CreditLimit=1000” and “Go CreditCard”. The rule in column I has action flags of “1500” for the rule “Set CreditLimit=?” and “Checking” for the rule “Go ?”. Therefore, if the rule in column I is matched, then the actions that are taken become “Set CreditLimit=1500” and “Go Checking”. The rule in column J has action flags of “1500” for the rule “Set CreditLimit=?” and “CreditCard” for the rule “Go ?”. Therefore, if the rule in column J is matched, then the actions that are taken become “Set CreditLimit=1500” and “Go CreditCard”. Finally, the default rule in column K has an action flag of “Review” for the rule “Go ?”. If the default rule in column K is matched, then the action that is taken becomes “Go Review”.

The set(s) of data can be input in a spreadsheet format, such as in a datasheet that is a separate worksheet of the user interface 102, exemplified in the screenshot of FIG. 7B. Business rules in a decision table or decision matrix can be applied against the set(s) of data. The datasheet 750 in FIG. 7B contains a set of data 754 that can be applied against the rules implemented in the decision table 700 of FIG. 7A, for example. Each column in the set of data can correspond to an attribute in the decision table. As seen in FIG. 7B, the set of data 754 includes columns for the attributes “Age”, “Debt”, and “Score”. The set of data may be, for example, a set of data for testing and validating the business rules, such as data that functions as boundary tests to ensure the business rules are fully exercised. The set of data may also include an actual sample that is arbitrary and/or anonymized to examine how the business rules are evaluated in a real world situation. The datasheet 750 may also include descriptive and configuration information 752, such as a name identifying the datasheet, a description of the datasheet, and timestamp information. In addition, the datasheet 750 may include result columns that are automatically created and that contain detailed results of the rule execution for each corresponding decision table and/or decision matrix for a given row (transaction) in the datasheet 750. The result columns in the datasheet 750 may be helpful for purposes of impact analysis and performance monitoring.

A dictionary worksheet (not shown) may also be included in the user interface 102 so that a user can define the name of attributes for use in the decision table, decision matrix, and/or datasheet. The dictionary worksheet can also be automatically created upon the input of a new attribute. The dictionary worksheet may be utilized by an external decision engine during run time execution. In particular, the external decision engine can pass the attributes in the dictionary worksheet to the pertinent decision table or decision matrix that contains a particular set of business rules, during run time execution. Similarly, the decision table or decision matrix may return a set of actions that result from applying data to the decision table or decision matrix so that the external decision engine can use the actions to drive the remainder of a decisioning flow.

Other exemplary decision tables are shown in FIGS. 5 and 6. The decision table 500 in FIG. 5, for example, includes descriptive and configuration information 502, conditions 504, rules 506, actions 508, and action flags 510. The conditions 504 specify that data corresponding to the attribute “AB 123” is compared with the operator “<=” to determine if the data is less than or equal to the value “100”, data corresponding to the attribute “CA001” is compared with the operator “<=” to determine if the data is less than or equal to the value “5”, data corresponding to the attribute “SPECIALFLAG” is compared with the operator “=” to determine if the data is equal to the value “Y”, and data corresponding to the attribute “CARDS” is compared with the operator “>=” to determine if the data is greater than or equal to the value “1”. There are three rules in the rules 506 of the decision table 500. The first rule specifies that if data corresponding to the AB123 attribute is less than or equal to 100, data corresponding to the CA001 attribute is less than or equal to 5, and data corresponding to the SPECIALFLAG attribute is Y, then that rule would be matched, and the “Go Approved” action would be taken. The second rule specifies that if data corresponding the AB123 attribute is less than or equal to 100, data corresponding to the CA001 attribute is less than or equal to 5, and data corresponding to the CARDS attribute is greater than or equal to 1, then that rule would be matched, and the “Go Approved” action would be taken. The third rule is a default rule that specifies that if none of the other rules match, then the default rule is matched, and the “Set RC=251” and “Go Process Complete” actions would be taken.

In FIG. 6, the decision table 600 includes configuration information 602, conditions 604, rules 606, actions 608, and action flags 610. The conditions 604 specify that data corresponding to the attribute “Milestone2” is compared with the operator “=” to determine if the data is equal to the value “PASS”, data corresponding to the attribute “VTG2ATOT” is compared with the operator “>=” to determine if the data is greater than or equal to the values specified in the rules 606, and data corresponding to the attribute “tb100” is compared with the operator “<” to determine if the data is less than the values specified in the rules 606. The conditions 604 further specify that data corresponding to the attribute “tb002” is compared with the operator “>=” to determine if the data is greater than or equal to the values specified in the rules 606, data corresponding to the attribute “tb027” is compared with the operator “<=” to determine if the data is less than or equal to the values specified in the rules 606, and data corresponding to the attribute “tb005” is compared with the operator “>=” to determine if the data is greater than or equal to the values specified in the rules 606.

There are five rules in the rules 606 of the decision table 600. The first rule specifies that if data corresponding to the Milestone2 attribute equals PASS, data corresponding to the VTG2ATOT attribute is greater than or equal to 800, data corresponding to the tb100 attribute is less than 5, data corresponding to the tb002 attribute is greater than or equal to 1, data corresponding to the tb027 attribute is less than or equal to 0, and data corresponding to the tb005 attribute is greater than or equal to 12, then that rule would be matched. The actions taken if this rule is matched would be “set Milestone3=Product_Assignment”, “set RiskTier=A”, “set Product=Signature”, “set Rewards=Y”, and “Go Line_Assignment”. The second rule specifies that if data corresponding to the Milestone2 attribute equals PASS, data corresponding to the VTG2ATOT attribute is greater than or equal to 700, data corresponding to the tb100 attribute is less than 5, data corresponding to the tb002 attribute is greater than or equal to 1, data corresponding to the tb027 attribute is less than or equal to 0, and data corresponding to the tb005 attribute is greater than or equal to 12, then that rule would be matched. The actions taken if this rule is matched would be “set Milestone3=Product_Assignment”, “set RiskTier=B”, “set Product=Platinum”, “set Rewards=Y”, and “Go Line_Assignment”.

The third rule specifies that if data corresponding to the Milestone2 attribute equals PASS, data corresponding to the VTG2ATOT attribute is greater than or equal to 650, data corresponding to the tb100 attribute is less than 9, data corresponding to the tb002 attribute is greater than or equal to 3, data corresponding to the tb027 attribute is less than or equal to 1, and data corresponding to the tb005 attribute is greater than or equal to 12, then that rule would be matched. The actions taken if this rule is matched would be “set Milestone3=Product_Assignment”, “set RiskTier=C”, “set Product=Gold”, “set Rewards=Y”, and “Go Line_Assignment”. The fourth rule specifies that if data corresponding to the Milestone2 attribute equals PASS, data corresponding to the VTG2ATOT attribute is greater than or equal to 600, data corresponding to the tb100 attribute is less than 9, data corresponding to the tb002 attribute is greater than or equal to 3, data corresponding to the tb027 attribute is less than or equal to 2, and data corresponding to the tb005 attribute is greater than or equal to 12, then that rule would be matched. The actions taken if this rule is matched would be “set Milestone3=Product_Assignment”, “set RiskTier=D”, “set Product=Classic”, “set Rewards=N”, and “Go Line_Assignment”. The default rules would take the actions of “set Milestone3=Product_Assignment”, “set RiskTier=X”, “set Product=No_Offer”, “set Rewards=N”, and “Go Set_Decision”.

Decision matrices are similar to decision tables, and may include conditions, rules, actions, and action flags. Decision matrices can contain the same logic as a decision table in a reduced form, such as where the choice of actions is organized two-dimensionally. Using a decision matrix may be helpful in some situations to specify complex rules and actions that include two dimensional conditions with multiple cut-off points. For example, in FIG. 8, the decision matrix 800 includes conditions 804, including attributes, operators, default values, and cell counts for specifying a grid 806, and actions 808. The grid 806 includes the rules and action flags. The decision matrix 800 may also include descriptive and configuration information 802, such as a name identifying the decision matrix, a description of the decision matrix, the script utilized to interpret the decision matrix, a selection of the set(s) of data to be applied to the decision matrix, and timestamp information.

Similar to the decision tables described above, the conditions for a decision matrix are a combination of attribute, operator, and value that are evaluated against the set(s) of data. In the case of a decision matrix, the values are specified in the grid, such as the grid 806 in FIG. 8. The operators for a decision matrix can include, for example, equal (“=”), a range inclusive of the endpoints (“:”), a range inclusive of the bottom of the range and up to, but not including the top of the range (“:<”), a range not including the bottom of the range but including the top of the range (“<:”), and the presence of the value in a list (“in”). Other operators may also be used. A question mark (“?”) as used in the decision table may be implied in a decision matrix to specify that the value to be compared is taken from the grid of the decision matrix and substituted into the conditions. The value may include any alphabetic, numeric, or alphanumeric value. A default value may be specified if the attribute in the set of data has a blank value.

For example, in FIG. 8, the decision matrix 800 includes that the data corresponding to the attribute “RiskScore” is compared with the operator “:<” to determine if the data is below the range of values specified in the grid 806, and data corresponding to the attribute “CustCode” is compared with the operator “=” to determine if the data is equal to the values specified in the grid 806. In particular, the grid 806 specifies six value ranges for the attribute RiskScore—“MIN:10”, “10:20”, “20:25”, “25:30”, “32:50”, and “50:MAX”. The grid 806 specifies five values for the attribute CustCode—“A”, “B”, “C”, “D” and “ELSE”. Therefore, each rule is a combination of conditions that utilizes the grid 806 to determine if there is a match and whether the corresponding actions are to be taken.

In the decision matrix 800, the actions to be taken are “set limit=?” and “Go next”. The value substituted into the “set limit=?” action is taken from the grid 806, depending on the data corresponding to the attributes. For example, if the data corresponding to the RiskScore attribute is 23 and the data corresponding to the CustCode attribute is B, then the actions taken would be “set limit=300” and “Go next”. As another example, if the data corresponding to the RiskScore attribute is 53 and the data corresponding to the CustCode attribute is D, then the actions taken would be “set limit=3000” and “Go next”. In the example of the decision matrix 800, the “Go next” action is always taken since the default value of that action is set to “X”.

FIG. 9 shows an exemplary decision matrix 900 and an equivalent decision table 950. The business rules included in the decision matrix 900 and the decision table 950 are identical. However, it can be seen that the decision matrix 900 is specified more compactly, which can ease the inputting of the business rules by the user. In particular, both the decision matrix 900 and the decision table 950 include the attributes “score” and “risk_flag”. The operators that are used differ, but are equivalent when the values in the rules are taken into account. For example, data corresponding to the attribute “score” in the decision matrix 900 is compared with the operator “:<” to determine if the data is in a range from the grid (not including the bottom of the range), such as MIN:100, 100:660, or 660:MAX. In the decision table 950, data corresponding to the attribute “score” is compared with the operators “<”, “:<”, and “>=” against the same values in the rules portion of the decision table 900. The actions in the decision matrix 900 and the decision table 950 each include “set level=?” and “Go next”. The values substituted in the “set level=?” action are also the same. For example, if the data corresponding to the attribute score is 440 and the data corresponding to the attribute “risk_flag” is “Y”, then the actions taken would be “set level=900” and “Go next”. As another example, if the data corresponding to the attribute score is 750 and the data corresponding to the attribute “risk_flag” is “N”, then the actions taken would be “set level=0” and “Go next”.

The business rules in a decision table or decision matrix may be applied against one or more sets of data with an internal decision engine 106 in response to the user issuing a run command to the business rule development module 104, such as by pressing the “Run Now” button in the user interface 102, as seen in FIGS. 5, 7A, and 8, or if calculations, e.g., applying the business rules against the set(s) of data, are automatically performed when there is a change to the decision table, decision matrix, and/or set(s) of data. Rule feedback can be provided by the module 104, based on the results of calculations, such as data coverage indicators and data coverage statistics. Data coverage indicators may include colors, shading, and/or other indications, for example, to indicate whether a business rule always fails, always passes, is not reached, or is fully exercised with respect to the set(s) of data. For example, in FIGS. 5, 6, 7A, 8, and 9, the cells that comprise the rules 506, 606, 706, and 806 can be color-coded in the user interface 102 based on the amount of data coverage attained by a particular set of data. For example, in FIG. 5, for the first rule, the comparison of the data corresponding to the attributes AB123 and CA001 with their respective values are fully exercised, and the comparison of the data corresponding to the attribute SPECIALFLAG with the value Y always passes. In this way, a user can quickly be informed as to whether the business rules are being thoroughly tested and validated and/or whether other sets of data are needed to rigorously test and validate the business rules implemented in a decision table or decision matrix.

Data coverage statistics may include counts of how much data passes or fails a rule. FIGS. 5, 7A, 8, and 9 show exemplary counts of how much data passes or fails a rule in the user interface 102. For example, in FIG. 5, the row beneath the action flags 510 may indicate the number of rows in the set of data that matched each rule/column. In this case, the first rule is matched by 3053 rows in the set of data, the second rule is not matched by any rows of the set of data, and the third rule is matched by 244 rows in the set of data. This rule count feedback is consistent with the color-coded rule feedback for FIG. 5. In particular, for the second rule, the comparison of the data corresponding to the attribute CA001 with the value 5 always fails so that this rule is never matched and, as such, the rule count feedback is 0 for this rule. In the case of a decision matrix, such as in FIG. 8, the rule count feedback may be provided in each cell of the grid 806. Reporting data may also be provided as rule feedback by the module on the user interface 102 for rule counts, pass counts, and fail counts, as shown in FIGS. 5 and 7A. The pass counts and fail counts may give the actual cell-level pass and fail counts, respectively, for each of the rules. This information may be utilized for analysis and reporting purposes. In some embodiments, charts or other graphical representations may be generated based on the rule feedback and/or the set of data.

The business rules implemented in a decision table or decision matrix, and/or the set(s) of data, can be changed by the user in the user interface 102. For example, the user may change the business rules and/or the data if the data coverage was not sufficient or unexpected, or if the user wishes to use a different set of data to test and validate the business rules. Depending on which changes are made, the module 104 can apply the changed business rules (or original business rules) to the set(s) of data (or the changed set(s) of data) by utilizing the internal decision engine 106. New rule feedback will be provided on the user interface 102 by the module 104, based on the new calculations.

A user can also generate importable business rules from the module 104 for use in an external decision engine 108. This may be done, for example, when the user determines that the business rules have been sufficiently tested and validated. The importable business rules may be based on the business rules implemented in the decision table or decision matrix, and may be adapted to be executed by the external decision engine 108. In some embodiments, the module 104 may generate the business rules in a machine-readable format that can be executed by a run time application that understands the format, such as the external decision engine 108. The machine-readable format may be in a text format, XML format, or other suitable format, for example. In other embodiments, the module 104 can directly export the business rules from the module 104 to the external decision engine 108.

FIG. 2 is a block diagram of a computing device 200 housing executable software used to facilitate the business rule development system 100. One or more instances of the computing device 200 may be utilized to implement any, some, or all of the components in the system 100, including the business rule development module 104 and the internal decision engine 106. Computing device 200 includes a memory element 204. Memory element 204 may include a computer readable medium for implementing the system 100, and for implementing particular system transactions. Memory element 204 may also be utilized to implement databases. Computing device 200 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the system 100 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the system 100, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, Lua, Visual Basic, and Visual Basic For Applications. Components of the system 100 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The system 100 and operating system 212, in whole or in part, may be read by processor 202, buffered within processor 202, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

For purposes of connecting to other computing devices, computing device 200 is equipped with network communication equipment and circuitry. In a preferred embodiment, the network communication equipment includes a network card such as an Ethernet card, or a wireless connection card. In a preferred network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

An embodiment of a process 300 for developing business rules for an external decision engine is shown in FIG. 3. The process 300 can result in providing rule feedback based on applying business rules on one or more sets of data, and generating importable business rules adapted to be executed by an external decision engine. Users utilizing systems, such as the business rule development system 100, that implement the process 300 can quickly and easily input, change, and validate business rules prior to deployment in the external decision engine.

At step 302, a user interface for inputting business rules and one or more set(s) of data may be provided, where the format of the business rules is a decision table or a decision matrix. In some embodiments, the format of the business rules may be in a decision tree or other type of decision structure. The user interface may be a spreadsheet or worksheet, and may be included as an add-in to spreadsheet software, such as Microsoft Excel, for example. The business rules and the set(s) of data may be received at step 304 from the user interface. A user may input the business rules in formats such as a decision table and/or a decision matrix. Decision tables and decision matrices may include elements such as conditions, rules, actions, action flags, and/or grids that correspond to the logic of business rules composed by the user. Further details of decision tables and decision matrices are described above. The set(s) of data may also be input in a datasheet, such as a separate worksheet of the user interface. The attributes in the set(s) of data may correspond to the attributes of the conditions in a decision table and/or decision matrix.

At step 306, the business rules, as implemented in a decision table or decision matrix, may be applied on the set(s) of data and rule feedback may be generated. FIG. 4 describes further details of an embodiment of step 306. In particular, at step 402, the business rules may be executed on the set(s) of data using an internal decision engine. The internal decision engine may have the same or similar functionality as an external decision engine but may not include certain features that the external decision engine may have. In any case, the internal decision engine will apply the business rules on the set(s) of data in the same way as the external decision engine would. However, the external decision engine may have certain different features and/or additional features, for example. At step 404, data coverage indicators may be generated, based on applying the business rules on the set(s) of data. The data coverage indicators may include, for example, colors to indicate whether a business rule always fails, always passes, is not reached, or is fully exercised with respect to the set(s) of data. Data coverage statistics may include counts of how much data passes or fails a rule, and may be generated at step 406, based on applying the business rules on the set(s) of data.

Returning to the process 300 shown in FIG. 3, the rule feedback generated at step 306 may be provided on the user interface at step 308. As noted above, the rule feedback may include colors and/or statistics to show the data coverage attained when applying the business rules on the set(s) of data. At step 310, it can be determined whether there are any changes to the business rules, e.g., the decision table or decision matrix in the user interface, and/or to the set(s) of data. A user may make changes to the business rules if the data coverage was not sufficient or unexpected, or if the user wishes to use a different set of data to test and validate the business rules, for example. If there are changes to the business rules and/or the set of data at step 310, then the process 300 returns to step 306 to apply the changed business rules (or original business rules) to the set(s) of data (or the changed set(s) of data), depending on what changes were made. However, if there are not changes to the business rules or the set(s) of data at step 310, then at step 312, importable business rules may be generated that are based on the business rules in the decision table or decision matrix. The user may wish to export the business rules, for example, when it is determined that the business rules have been sufficiently tested and validated. The importable business rules may be a machine-readable file or may be directly exported to an external decision engine, for example.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method of developing a plurality of business rules for an external decision engine, using a processor, the method comprising:
providing, using the processor, a user interface for enabling a user to input the plurality of business rules and one or more sets of data, wherein a format of the plurality of business rules is in one or more of a decision table or a decision matrix;
receiving the plurality of business rules and the one or more sets of data from the user interface at the processor;
applying the plurality of business rules on the one or more sets of data to generate rule feedback, using the processor, wherein the rule feedback denotes coverage of the one or more sets of data by the plurality of business rules;
providing the rule feedback on the user interface, using the processor, the rule feedback based on applying the plurality of business rules; and
generating a plurality of importable business rules based on the plurality of business rules, using the processor, the plurality of importable business rules adapted to be executed by the external decision engine.

2. The method of claim 1, wherein applying the plurality of business rules comprises executing the plurality of business rules on the one or more sets of data with an internal decision engine, using the processor, to generate the rule feedback.

3. The method of claim 1, wherein:
the rule feedback comprises a data coverage indicator of the coverage of the one or more sets of data by the plurality of business rules;
applying the plurality of business rules comprises applying the plurality of business rules on the one or more sets of data to generate the data coverage indicator, using the processor; and
providing the rule feedback comprises providing the data coverage indicator on the user interface, using the processor.

4. The method of claim 3, wherein the data coverage indicator indicates whether one or more of the plurality of business rules always fails, always passes, is not reached, or is fully exercised with respect to the one or more sets of data.

5. The method of claim 3, wherein the data coverage indicator comprises one or more colors to uniquely indicate whether one or more of the plurality of business rules always fails, always passes, is not reached, or is fully exercised with respect to the one or more sets of data.

6. The method of claim 1, wherein:
the rule feedback comprises data coverage statistics related to the coverage of the one or more sets of data by the plurality of business rules;
applying the plurality of business rules comprises applying the plurality of business rules on the one or more sets of data to generate the data coverage statistics, using the processor; and
providing the rule feedback comprises providing the data coverage statistics on the user interface, using the processor.

7. The method of claim 1, wherein generating the plurality of importable business rules comprises generating the plurality of importable business rules in a machine-readable format comprising the plurality of business rules, using the processor.

8. The method of claim 1, wherein:
the processor is in communication with the external decision engine; and
generating the plurality of importable business rules comprises transmitting the plurality of business rules from the processor to the external decision engine.

9. The method of claim 1, further comprising enabling the user interface to accept a change to at least one rule of the plurality of business rules and a change to the one or more sets of data after the plurality of business rules and the one or more sets of data are received, using the processor;
wherein applying the plurality of business rules comprises applying the changed business rule on the changed one or more sets of data to generate the rule feedback, using the processor.

10. The method of claim 1, wherein the plurality of business rules comprises one or more of a condition, a rule, or an action, wherein:
the condition comprises one or more of an attribute, a value, an operator for comparing the attribute and the value, or a default value;
the rule comprises a Boolean construct of the condition; and
the action is executed based on the rule.

11. The method of claim 10, wherein the action comprises one or more of setting a variable within the external decision engine, or returning a final value for directing a next action of the external decision engine.

12. A system for developing a plurality of business rules for an external decision engine, the system comprising:
a processor;
a user interface in communication with the processor;
a memory in communication with the processor, the memory for storing:
a business rule development module for:
providing the user interface for enabling a user to input the plurality of business rules and one or more sets of data, wherein a format of the plurality of business rules is in one or more of a decision table or a decision matrix;
receiving the plurality of business rules and the one or more sets of data from the user interface;
applying the plurality of business rules on the one or more sets of data to generate rule feedback, wherein the rule feedback denotes coverage of the one or more sets of data by the plurality of business rules;
providing the rule feedback on the user interface, the rule feedback based on applying the plurality of business rules; and
generating a plurality of importable business rules based on the plurality of business rules, the plurality of importable business rules adapted to be executed by the external decision engine.

13. The system of claim 12, wherein:
the memory further comprises an internal decision engine; and
the business rule development module applies the plurality of business rules by executing the plurality of business rules on the one or more sets of data with the internal decision engine to generate the rule feedback.

14. The system of claim 12, wherein:
the rule feedback comprises a data coverage indicator of the coverage of the one or more sets of data by the plurality of business rules;
the business rule development module applies the plurality of business rules by applying the plurality of business rules on the one or more sets of data to generate the data coverage indicator; and
the business rule development module provides the rule feedback by providing the data coverage indicator on the user interface.

15. The system of claim 14, wherein the data coverage indicator indicates whether one or more of the plurality of business rules always fails, always passes, is not reached, or is fully exercised with respect to the one or more sets of data.

16. The system of claim 14, wherein the data coverage indicator comprises one or more colors to uniquely indicate whether one or more of the plurality of business rules always fails, always passes, is not reached, or is fully exercised with respect to the one or more sets of data.

17. The system of claim 12, wherein:
the rule feedback comprises data coverage statistics related to the coverage of the one or more sets of data by the plurality of business rules;
the business rule development module applies the plurality of business rules by applying the plurality of business rules on the one or more sets of data to generate the data coverage statistics; and
the business rule development module provides the rule feedback by providing the data coverage statistics on the user interface.

18. The system of claim 12, wherein the business rule development module generates the plurality of importable business rules by generating the plurality of importable business rules in a machine-readable format comprising the plurality of business rules.

19. The system of claim 12, wherein:
the processor is in communication with the external decision engine; and
the business rule development module generates the plurality of importable business rules by transmitting the plurality of business rules to the external decision engine.

20. The system of claim 12, wherein the business rule development module is further for enabling the user interface to accept a change to at least one rule of the plurality of business rules and a change to the one or more sets of data after the plurality of business rules and the one or more sets of data are received;
wherein the business rule development module applies the plurality of business rules by applying the changed business rule on the changed one or more sets of data to generate the rule feedback.

21. The system of claim 12, wherein the plurality of business rules comprises one or more of a condition, a rule, or an action, wherein:
the condition comprises one or more of an attribute, a value, an operator for comparing the attribute and the value, or a default value;
the rule comprises a Boolean construct of the condition; and
the action is executed based on the rule.

22. The system of claim 21, wherein the action comprises one or more of setting a variable within the external decision engine, or returning a final value for directing a next action of the external decision engine.
